(19) United States
(12) Patent Application Publication
(10) Pub. No.: US 2026/0195645 A1
(43) Pub. Date: Jul. 9, 2026

(54) METHOD, DEVICE, AND APPARATUS WITH MULTI-MODAL BASE MODEL TRAINING

(71) Applicant: Samsung Electronics Co., Ltd., Suwon-si (KR)

(72) Inventors: Joonho JANG, Suwon-si (KR); Sangil JUNG, Suwon-si (KR)

(73) Assignee: Samsung Electronics Co., Ltd., Suwon-si (KR)

(21) Appl. No.: 19/254,822

(22) Filed: Jun. 30, 2025

(30) Foreign Application Priority Data
Jan. 7, 2025 (KR) 10-2025-0002499

(51) Int. Cl. G06N 20/00; G06F 40/284

(52) U.S. Cl. CPC G06N 20/00; G06F 40/284

(57) ABSTRACT

A processor-implemented method including generating a token data set based on document information of a target document, generating a first chunk including first token data determined based on the token data set, generating first summary token data for the first chunk, generating a second chunk based on second token data and the first summary token data, the second token data being determined based on the token data set, and training a multi-modal base model based on the second chunk.

### CROSS-REFERENCE TO RELATED APPLICATIONS

This application claims the benefit under 35 USC § 119(a) of Korean Patent Application No. 10-2025-0002499, filed on Jan. 7, 2025, in the Korean Intellectual Property Office, the entire disclosure of which is incorporated by reference herein for all purposes.

### BACKGROUND

### 1. Field

The following description relates to a neural network-based model, and more particularly, to a method, device, and apparatus for training a model using multi-modal data.

### 2. Description of Related Art

Multi-modal data may be a data set in which different forms of data are combined, and that data set may include data from various modalities such as text, images, voice, and video. Multi-modal data may be used to train a neural network-based model (e.g., artificial intelligence) that imitates the complex cognitive abilities of humans. For example, just as a person sees a picture and expresses the meaning of the picture in text or hears a voice and imagines a visual scene, a multi-modal base model may provide deeper understanding by simultaneously processing and integrating multiple forms of data.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a general aspect, here is provided a processor-implemented method including generating a token data set based on document information of a target document, generating a first chunk including first token data determined based on the token data set, generating first summary token data for the first chunk, generating a second chunk based on second token data and the first summary token data, the second token data being determined based on the token data set, and training a multi-modal base model based on the second chunk.

A first length of the first token data and a second length of the second token data may be less than or equal to a preset first target length.

A third length of the first chunk and a fourth length of the second chunk may be less than or equal to a second target length, the second target length being greater than the first target length.

The generating of the first summary token data for the first chunk may include generating the first summary token data by processing the first chunk based on a first query for the first chunk.

The generating of the first summary token data may include generating the first summary token data by inputting the first query and the first chunk to a summary model.

The method may include generating global summary token data based on the token data set, and the generating of the second chunk may include generating the second chunk based on the second token data, the first summary token data, and the global summary token data.

The target document may include a portion in which an image and a text intersect with each other.

The generating of the token data set may include generating first image token data by processing, using an image encoder, a first image of the target document.

The multi-modal base model may include a multi-modal large language model (LLM).

In a general aspect, here is provided an electronic device including at least one processor including processing circuitry, a memory including one or more storage media configured to store instructions, and the instructions, when executed by the at least one processor, cause the electronic device to generate a token data set based on document information of a target document, generate a first chunk including first token data determined based on the token data set, generate first summary token data for the first chunk, generate a second chunk based on second token data and the first summary token data, the second token data being determined based on the token data set, and train a multi-modal base model based on the second chunk.

A first length of the first token data and a second length of the second token data may be less than or equal to a preset first target length.

A third length of the first chunk and a fourth length of the second chunk may be less than or equal to a second target length, the second target length being greater than the preset first target length.

The instructions, when executed by the at least one processor, may further cause the electronic device to obtain a first query for the first chunk and generate the first summary token data by processing the first chunk based on the first query.

The instructions, when executed by the at least one processor, may further cause the electronic device to generate the first summary token data by inputting the first query and the first chunk to a summary model.

The instructions, when executed by the at least one processor, may further cause the electronic device to generate global summary token data based on the token data set and generate the second chunk based on the second token data, the first summary token data, and the global summary token data.

In a general aspect, here is provided a processor-implemented method including generating a token data set based on document information of a target document, generating global summary token data based on the token data set, generating a first chunk including first token data and the global summary token data, the first token data being determined based on the token data set, and training a multi-modal base model based on the first chunk.

The method may include generating first summary token data by processing the first chunk based on a first query for the first chunk, generating a second chunk based on second token data, the global summary token data, and the first summary token data, the second token data being determined based on the token data set, and training the multi-modal base model based on the second chunk.

A first length of the first token data and a second length of the second token data may be less than or equal to a preset first target length.

A third length of the first chunk and a fourth length of the second chunk may be less than or equal to a second target length, the second target length being greater than the preset first target length.

The generating of the first summary token data may include generating the first summary token data by inputting the first query and the first chunk to a summary model.

Other features and aspects will be apparent from the following detailed description, the drawings, and the claims.

### BRIEF DESCRIPTION OF THE DRAWINGS

FIG. 1 illustrates an example document with a text and an image being disposed by intersecting with each other and with lengths of tokens for the document according to one or more embodiments.

FIG. 2 illustrates an example electronic device according to one or more embodiments.

FIG. 3 illustrates an example method of training a multi-modal base model according to one or more embodiments.

FIG. 4 illustrates an example method of generating a second chunk based on first summary token data according to one or more embodiments.

FIG. 5 illustrates an example method of training the multi-modal base model based on a second chunk according to one or more embodiments.

FIG. 6 illustrates an example method of training a multi-modal base model based on a chunk according to one or more embodiments.

FIG. 7 illustrates an example method of generating a first chunk and a second chunk according to one or more embodiments.

FIG. 8 illustrates an example method of training the multi-modal base model based on a second chunk, second token data, and first summary token data according to one or more embodiments.

Throughout the drawings and the detailed description, unless otherwise described or provided, it may be understood that the same drawing reference numerals refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application. The use of the term “may” herein with respect to an example or embodiment (e.g., as to what an example or embodiment may include or implement) means that at least one example or embodiment exists where such a feature is included or implemented, while all examples are not limited thereto. The use of the terms “example”, “embodiment”, and “example embodiment” herein have a same meaning (e.g., the phrasing ‘in an or one example’ has a same meaning as ‘in an or one embodiment” and ‘in an or one example embodiment’), and “one or more examples” has a same meaning as “one or more embodiments” and “one or more example embodiments”. Still further, each of multiple or all separately described an/one “example”, “embodiment”, “example embodiment”, as well as “examples”, “embodiments”, “example embodiments”, herein may be included, in combination, in a same embodiment in any combination.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” specify the presence of stated features, numbers, operations, members, elements, and/or combinations thereof, other embodiments may exist where one or more of the stated features, numbers, operations, members, elements, and/or combinations thereof are not present.

Unless otherwise defined, all terms, including technical and scientific terms, used herein have the same meaning as commonly understood by one of ordinary skill in the art to which this disclosure pertains and specifically in the context on an understanding of the disclosure of the present application. Terms, such as those defined in commonly used dictionaries, are to be interpreted as having a meaning that is consistent with their meaning in the context of the relevant art and specifically in the context of the disclosure of the present application, and are not to be interpreted in an idealized or overly formal sense unless expressly so defined herein.

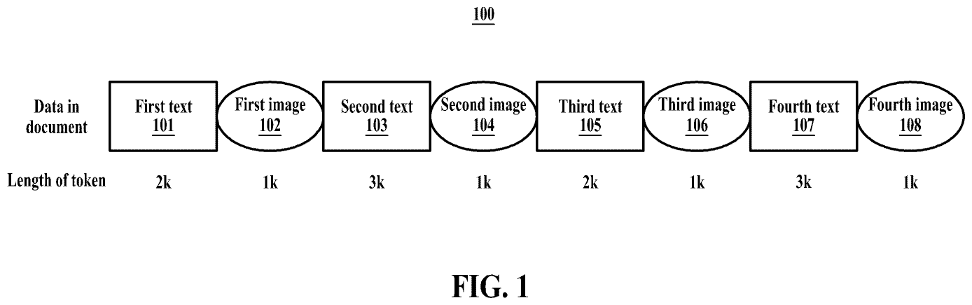

FIG. 1 illustrates an example document with a text and an image being disposed by intersecting with each other and with lengths of tokens for the document according to one or more embodiment.

A document including a portion in which a text and an image are disposed by intersecting with each other may be used to train a multi-modal base model. The multi-modal base model may be an artificial intelligence model that may process and understand various types of data simultaneously. A modality may be a form of data (e.g. text, image, voice, or video), and a multi-modal base model may perform comprehensive analysis and processing by combining various data modalities. A document including a portion in which a text and an image are disposed by intersecting with each other may be referred to as an interleaved image-text document. A document such as a paper, a web page, or a blog post in which texts and images intersect with each other may include a sequence format in which images and texts exist in order without distinction of modality. A document of this type may be essential for training a multi-modal base model. This type of document may not require separate labeling of tokens, as the context between tokens for the data in the document is maintained. Accordingly, documents in the format described above are widely used for pre-training of multi-modal base models.

Pieces of data corresponding to documents used for training may be converted into tokens, and a multi-modal base model may be trained based on the tokens. For example, a multi-modal base model may be trained such that highly correlated tokens have embedding vectors that are close in distance within an embedding space. In order for images and texts with different modalities to be used as inputs for a multi-modal base model, image tokens may be generated based on the images, and text tokens may be generated based on the texts. The forms of image tokens and text tokens may correspond to the token forms of a large language model (LLM). Since the length of an image token is often longer than the length of a text token, the total length of tokens generated for a single document may exceed the maximum token length that may be input to the multi-modal base model at one time. Accordingly, training a multi-modal base model may require chunking the entire tokens generated for a single document.

Referring to FIG. 1, in a non-limiting example, a document 100 may include text and images.

For example, the data in the document 100 may include a first text 101, a first image 102, a second text 103, a second image 104, a third text 105, a third image 106, a fourth text 107, and a fourth image 108. The token lengths of the first text 101, the first image 102, the second text 103, the second image 104, the third text 105, the third image 106, the fourth text 107, and the fourth image 108 may be 2 kilos (k), 1k, 3k, 1k, 2k, 1k, 3k, and 1k, respectively. When the maximum token length that may be input at one time to a multi-modal base model is 7k, a first chunk generated through first chunking may include tokens of the first text 101, the first image 102, the second text 103, and the second image 104, and a second chunk generated through second chunking may include tokens of the third text 105, the third image 106, the fourth text 107, and the fourth image 108.

When the token data by the first chunking and the token data by the second chunking are treated as separate tokens, the correlation between tokens by the context represented by the text and images in the document 100 may not be well reflected in the training of the multi-modal base model.

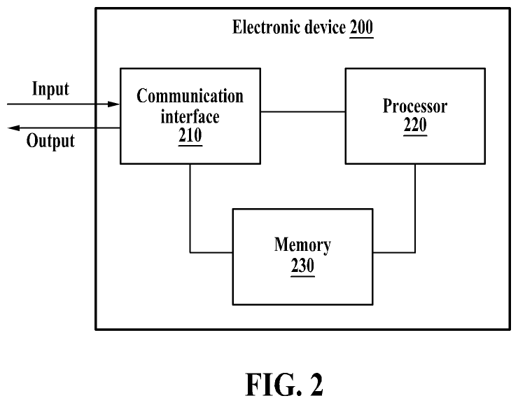

Hereinafter, a method of training a multi-modal base model to better reflect the context within a document is described in detail with reference to FIGS. 2 to 8.

FIG. 2 illustrates an example electronic device according to one or more embodiments.

Referring to FIG. 2, in a non-limiting example, an electronic device 200 may include a communicator 210, a processor 220, and a memory 230.

The communication interface 210 may be connected to the processor 220 and the memory 230 and transmit and receive data to and from the processor 220 and the memory 230. The communication interface 210 may be connected to another external device and transmit and receive data to and from the external device. Hereinafter, transmitting and receiving “A” may refer to transmitting and receiving “information or data indicating A”.

The communication interface 210 may be implemented as circuitry in the electronic device 200. For example, the communication interface 210 may include an internal bus and an external bus. In another example, the communication interface 210 may be an element that connects the electronic device 200 to the external device. The communication interface 210 may be an interface. The communicator 210 may receive data from the external device and transmit the data to the processor 220 and the memory 230.

The processor 220 may be configured to execute programs or applications to configure the processor 220 to control the electronic apparatus 200 to perform one or more or all operations and/or methods involving the reconstruction of images, and may include any one or a combination of two or more of, for example, a central processing unit (CPU), a graphic processing unit (GPU), a neural processing unit (NPU), tensor processing units (TPUs), a multi-core processor, a multiprocessor, an application-specific integrated circuit (ASIC), and a field-programmable gate array (FPGA)but is not limited to the above-described examples.

The memory 230 may include computer-readable instructions. The processor 220 may be configured to execute computer-readable instructions, such as those stored in the memory 230, and through execution of the computer-readable instructions, the processor 220 is configured to perform one or more, or any combination, of the operations and/or methods described herein. The memory 300 may be one or more of a volatile, nonvolatile memory, random-access memory (RAM), flash memory, a hard disk drive, and an optical disc drive.

The memory 230 may store data received by the communication interface 210 and data processed by the processor 220. For example, the memory 230 may store the program (or an application or software). For example, the stored program may be a set of syntaxes that are coded and executable by the processor 220 to train a multi-modal base model.

The memory 230 may include at least one volatile memory, non-volatile memory.

The electronic device 200 may include a communication device such as a smartphone and the like, a vehicle, such as an automobile and the like, a display device such as a TV and the like, a consumer electronic apparatus such as a washing machine and the like, a manufacturing apparatus, and the like.

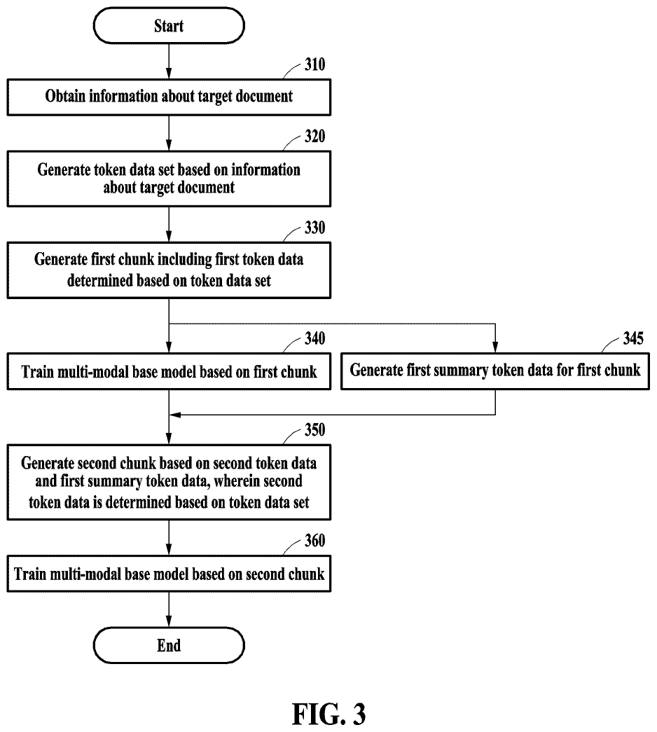

The communication interface 210, the processor 220, and the memory 230 are described in greater detail below with reference to FIGS. 3 to 9.

FIG. 3 illustrates an example method of training a multi-modal base model according to one or more embodiments.

Operations 310 to 360 may be performed by an electronic device (e.g., the electronic device 200 of FIG. 2). For example, the electronic device may include at least one processor (e.g., the processor 220 of FIG. 2) and a memory (e.g., the memory 230 of FIG. 2).

Referring to FIG. 3, in a non-limiting example, in operation 310, the electronic device may obtain information about a target document. For example, the target document may be an interleaved image-text document. The information about the target document may be data or a data file obtained by digitizing the target document.

In an example, in operation 320, the electronic device may generate a token data set based on the information about the target document. The electronic device may generate text token data for a text of the target document using a tokenizer. The electronic device may generate image token data for an image of the target document using an image encoder. For example, the image encoder may be an image encoder based on a convolutional neural network (CNN), an image encoder based on a vision transformer (ViT), or a contrastive language-image pre-training (CLIP) image encoder.

For example, when a first text, a first image, a second text, and a second image are sequentially arranged in the target document, the token data set may sequentially include first text token data of the first text, first image token data of the first image, second text token data of the second text, and second image token data of the second image. The electronic device may group token data based on the token data set. For example, the first token data may be determined such that the length of the first token data corresponding to a group is less than or equal to a preset first target length. The token data corresponding to a group may be a pre-chunk.

For example, when the maximum token length that may be input to the multi-modal base model to be trained is 8k, the first target length may be less than 8k. For example, when the maximum length for summary token data described below is set to 1k, the first target length may be 7k or less. As the maximum length of the summary token data increases, performance may improve as the context of the previous chunk is better reflected in the next chunk. However, there may be a trade-off relationship in which the training speed of a model decreases as the maximum length of the summary token data increases. When the length of the first text token data is 3k, the length of the first image token data is 3k, the length of the second text token data is 2k, the length of the second image token data is 4k, and the length of the first target is 7k, the first token data may include the first text token data and the first image token data. Since the total length of the first text token data and the first image token data is 6k, 1k-long token data may be used as dummy token data to generate 7k-long first token data. That is, a dummy token may be a padding token to pad the length of the token data.

In an example, in operation 330, the electronic device may generate a first chunk including first token data determined based on the token data set. For example, the electronic device may generate the first chunk using the first token data and padding data when the first chunk is the initial chunk for the target document. For example, when the first chunk is not the initial chunk for the target document, the electronic device may generate the first chunk using the first token data and summary token data generated for the previous chunk of the first chunk. The length of the first chunk may be less than or equal to a second target length (e.g., 8k), which exceeds the first target length (e.g., 7k).

In an example, in operation 340, the electronic device may train the multi-modal base model based on the first chunk. For example, a multi-modal base model may be trained such that highly correlated tokens have embedding vectors are close in distance within an embedding space.

When the first chunk includes not only the first token data but also the summary token data for the previous chunk, the context that the target document is intended to represent may be maintained within successive chunks.

In an example, in operation 345, the electronic device may generate the first summary token data for the first chunk. For example, the electronic device may generate the first summary token data for the first chunk using a summary model that is different from the multi-modal base model to be trained. The summary model may be a model that may process multi-modal data. For example, the length of the first summary token data may be preset. Thus, in an example, where the maximum token length that may be input to the multi-modal base model to be trained is 8k, and the length of the token data to be grouped (e.g., the first token data) is 7k or less, the length of the first summary token data may be 1k or less.

The electronic device may obtain a first query for the first chunk. For example, the first query may be a prompt such as “This is the part of a multi-modal document. Please summarize this part in a few sentences.” The electronic device may generate first summary data by processing the first chunk based on the first query. For example, the electronic device may generate the first summary token data by inputting the first query and the first chunk to the summary model.

Although operation 345 is illustrated as being performed in parallel with operation 340, operation 345 may be performed before operation 350 is performed and may be performed independently of operation 340.

In an example, in operation 350, the electronic device may generate a second chunk based on second token data and the first summary token data, wherein the second token data is determined based on the token data set. For example, the second chunk may include the second token data and the first summary data. The group of the second token data may be the next group of the group of the first token data.

In an example, in operation 360, the electronic device may train the multi-modal base model based on the second chunk. Since the second chunk includes not only the second token data but also the first summary token data for the first chunk, which is the previous chunk of the second chunk, the context that the target document is intended to represent may be maintained within the second chunk.

In an example, when there is additional token data, such as third token data, which would be the next token of the second token data, second summary token data for the second chunk may be generated. The description of a method of generating the second summary token data may be replaced with the description of the method of generating the first summary token data described above with reference to operation 345. When the second summary token data is generated, a third chunk may be generated to include the third token data and the second summary token data, and so on. The multi-modal base model may be trained based on the third chunk. Operations 340, 345, 350, and 360 may be performed repeatedly until all chunks for a token data set are used for the multi-modal base model.

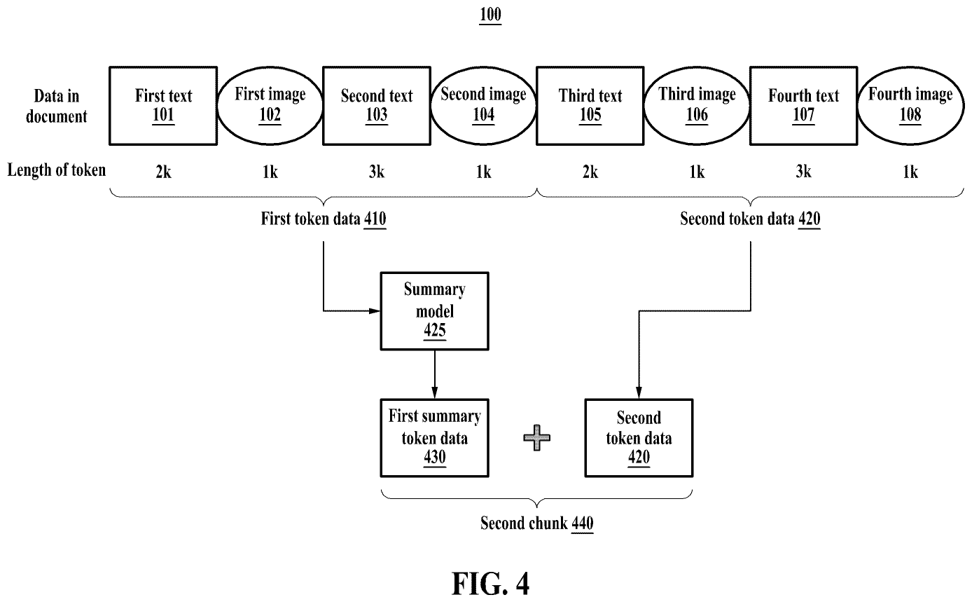

FIG. 4 illustrates an example method of generating a second chunk based on first summary token data according to one or more embodiments.

Referring to FIG. 4, in a non-limiting example, the data in the document 100 described above with reference to FIG. 1 may include the first text 101, the first image 102, the second text 103, the second image 104, the third text 105, the third image 106, the fourth text 107, and the fourth image 108. The token lengths of the first text 101, the first image 102, the second text 103, the second image 104, the third text 105, the third image 106, the fourth text 107, and the fourth image 108 may be 2k, 1k, 3k, 1k, 2k, 1k, 3k, and 1k, respectively. When the maximum token length that may be input to a multi-modal base model to be trained is 8k, and the length of the token data to be grouped (e.g., the first token data) is 7k or less, the length of the first summary token data may be 1k or less.

For example, first token data 410 may include tokens for the first text 101, the first image 102, the second text 103, and the second image 104, and thus in this example, the length of the first token data 410 may be 7k. An electronic device (e.g., the electronic device 200 of FIG. 2) may generate first summary token data 430 by inputting the first token data 410 or a first chunk including the first token data 410 to a summary model425.

For example, second token data 420 may include tokens for the second text 105, the second image 106, the third text 107, and the fourth image 108, and the length of the second token data 420 may be 7k. The electronic device may generate a second chunk 440 including the first summary token data 430 and the second token data 420. The multi-modal base model may be trained based on the second chunk 440.

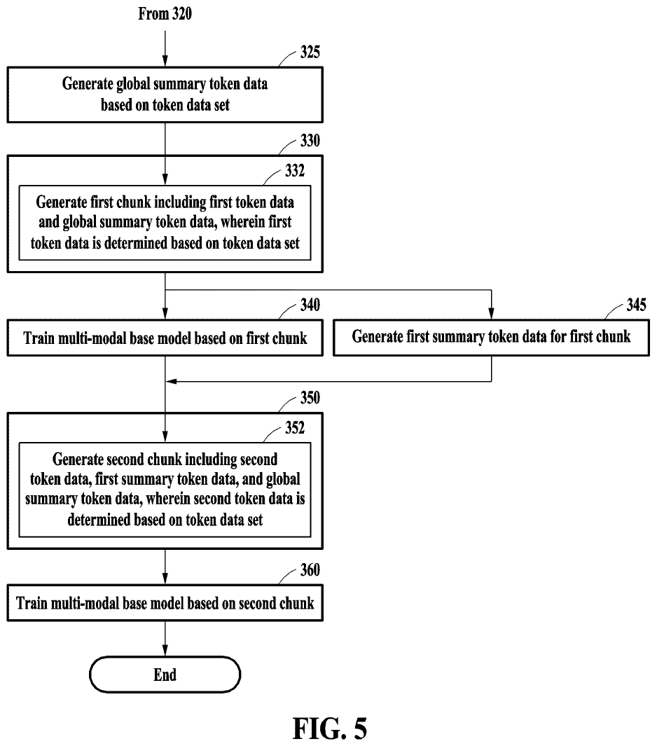

FIG. 5 illustrates an example method of training the multi-modal base model based on a second chunk according to one or more embodiments.

Referring to FIG. 5, in a non-limiting example, operation 320 described above with reference to FIG. 3 is performed, and then operation 325 may be further performed. Operation 325 may be performed by an electronic device (e.g., the electronic device 200 of FIG. 2).

In operation 325, the electronic device may generate global summary token data based on a token data set. For example, the electronic device may generate the global summary token data by adjusting the lengths of tokens in the token data set to correspond to a maximum input length of a summary model that generates the global summary token data and inputting, to the summary model, the tokens in the token data set of which the lengths are adjusted. For example, when the lengths of the tokens in the token data set are 20k and the maximum input length of the summary model is 8k, the lengths of the tokens in the token data set may be adjusted to be 8k. For example, some tokens may be randomly sampled to adjust the lengths of the tokens in the token data set. For example, image tokens among the tokens in the token data set may be deleted.

In an example, operation 330 described above with reference to FIG. 3 may include operation 332. Operation 332 may be performed by the electronic device (e.g., the electronic device 200 of FIG. 2).

In an example, in operation 332, the electronic device may generate the first chunk including the first token data and the global summary token data, wherein the first token data is determined based on the token data set. For example, when the maximum token length that may be input to the multi-modal base model to be trained is 8k, the length of the global summary token data is 1k or less, and the length of the summary token data is 1k or less, the length of the determined first token data may be 6k or less. When the first token data is a prior chunk that appears for the first time, the first chunk may include padding token data instead of the summary token data.

In an example, operation 350 described above with reference to FIG. 3 may include operation 352. Operation 352 may be performed by the electronic device (e.g., the electronic device 200 of FIG. 2).

In an example, in operation 352, the electronic device may generate a second chunk including the second token data, the first summary token data, and the global summary token data, wherein the second token data is determined based on the token data set. For example, when the maximum token length that may be input to the multi-modal base model to be trained is 8k, the length of the global summary token data is 1k or less, and the length of the first summary token data is 1k or less, the length of the second token data may be 6k or less.

Since the second chunk reflects the context of the entire target document through the global summary token data as well as the context of the first chunk based on the first summary token data, an embedding vector of the second token data determined through training of the multi-modal base model may be determined to be close to embedding vectors of other highly correlated tokens.

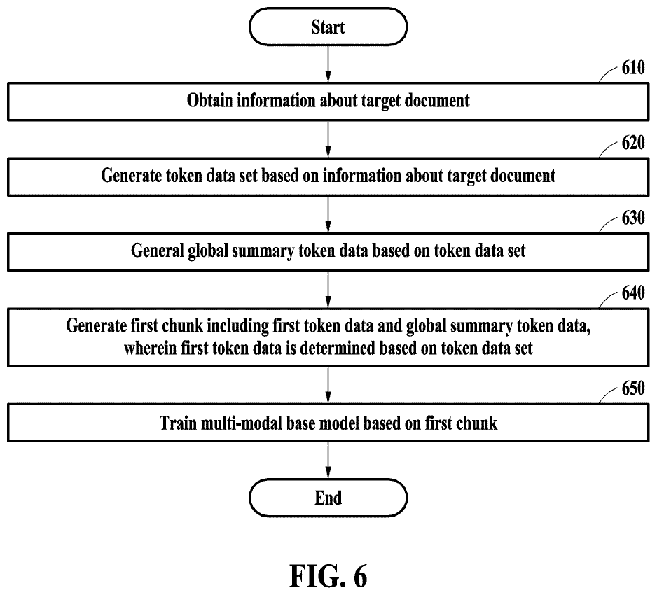

FIG. 6 illustrates an example method of training a multi-modal base model based on a chunk according to one or more embodiments.

Operations 610 to 650 may be performed by an electronic device (e.g., the electronic device 200 of FIG. 2). For example, the electronic device may include at least one processor (e.g., the processor 220 of FIG. 2) and a memory (e.g., the memory 230 of FIG. 2).

Referring to FIG. 6, in an example, in operation 610, the electronic device may obtain information about a target document. The description of operation 310 described above with reference to FIG. 3 may similarly apply to the description of operation 610.

In an example, in operation 620, the electronic device may generate a token data set based on the information about the target document. The description of operation 320 described above with reference to FIG. 3 may similarly apply to the description of operation 620.

In an example, in operation 630, the electronic device may generate global summary token data based on the token data set. The description of operation 332 described above with reference to FIG. 5 may be similarly applied to the description of operation 630.

In an example, in operation 640, the electronic device may generate a first chunk including first token data and the global summary token data, wherein the first token data is determined based on the token data set. For example, the electronic device may generate the first chunk using the first token data, the global summary token data, and padding data when the first chunk is the initial chunk for the target document. For example, when the first chunk is not the initial chunk for the target document, the electronic device may generate the first chunk using summary token data, the global summary token data, and the first token data generated for the previous chunk of the first chunk.

In an example, in operation 650, the electronic device may train the multi-modal base model based on the first chunk. The description of operation 340 described above with reference to FIG. 3 may similarly apply to the description of operation 650.

When there is second token data, which is the next token of the first token data, a second chunk may be generated using second token data and global summary token data. The multi-modal base model may be trained based on the second chunk. Operations 640 and 650 may be performed repeatedly until all chunks for the token data set are used for the multi-modal base model.

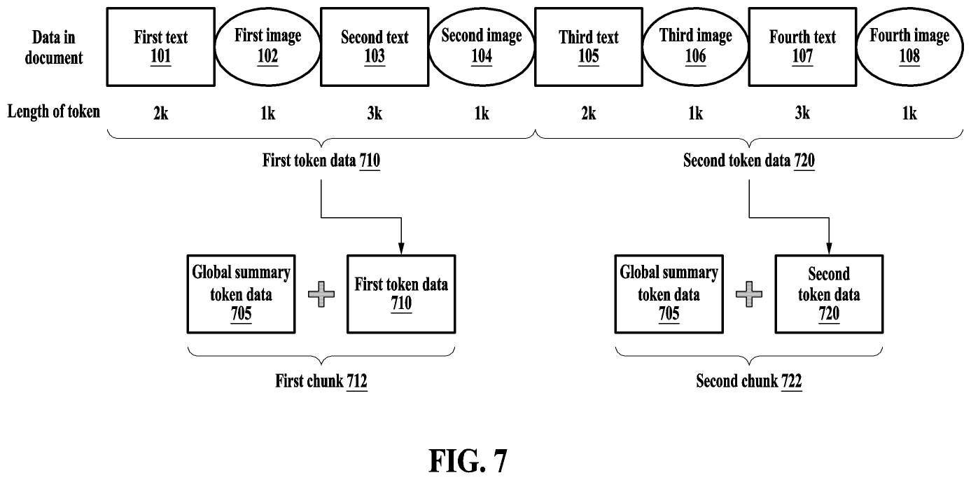

FIG. 7 illustrates an example method of generating a first chunk and a second chunk according to one or more embodiments.

Referring to FIG. 7, in a non-limiting example, the data in the document 100 described above with reference to FIG. 1 may include the first text 101, the first image 102, the second text 103, the second image 104, the third text 105, the third image 106, the fourth text 107, and the fourth image 108. The token lengths of the first text 101, the first image 102, the second text 103, the second image 104, the third text 105, the third image 106, the fourth text 107, and the fourth image 108 may be 2k, 1k, 3k, 1k, 2k, 1k, 3k, and 1k, respectively. When the maximum token length that may be input to a multi-modal base model to be trained is 8k, and the length of the token data to be grouped (e.g., the first token data) is 7k or less, the length of the global summary token data may be 1k or less.

For example, first token data 710 may include tokens for the first text 101, the first image 102, the second text 103, and the second image 104, and the length of the first token data 710 may be 7k. An electronic device (e.g., the electronic device 200 of FIG. 2) may generate global summary token data 705 by inputting a token data set corresponding to a target document to a summary model. The length of the token data set corresponding to the target document input to the summary model may be adjusted to correspond to the maximum input length of the summary model. A first chunk 712 may include global summary token data 705 and first token data 710. The multi-modal base model may be trained based on the first chunk 712.

In an example, second token data 720 may include tokens for the second text 105, the second image 106, the third text 107, and the fourth image 108, and the length of the second token data 720 may be 7k. A second chunk 722 may include the global summary token data 705 and the second token data 720. The multi-modal base model may be trained based on the second chunk 720.

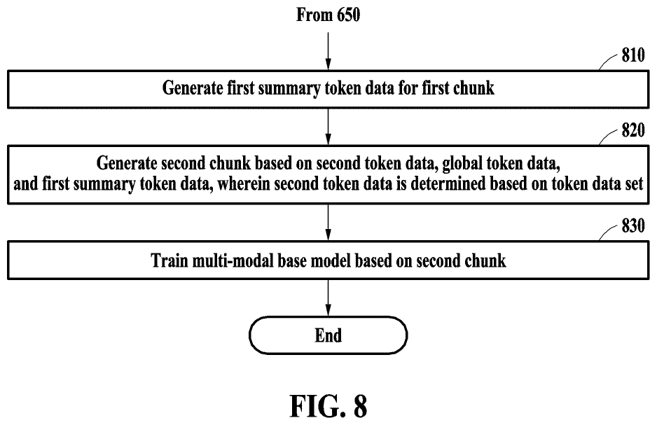

FIG. 8 illustrates an example method of training the multi-modal base model based on a second chunk, second token data, and first summary token data according to one or more embodiments.

Operations 810 to 830 of FIG. 8 may be performed after operation 650 described above with reference to FIG. 6 is performed. Operations 810 to 830 may be performed by an electronic device (e.g., the electronic device 200 of FIG. 2).

Referring to FIG. 8, in a non-limiting example, in operation 810, the electronic device may generate first summary token data for a first chunk (e.g., the first chunk 712 of FIG. 7). For example, when the first chunk includes first token data and global summary data, first summary token data for the first token data and the global summary data may be generated. The first summary token data may be generated for the first token data of the first chunk.

In an example, in operation 820, the electronic device may generate a second chunk based on second token data, global summary token data, and second summary token data, wherein the second token data is determined based on a token data set. The description of operation 352 described above with reference to FIG. 5 may be similarly applied to the description of operation 820.

In an example, in operation 830, the electronic device may train the multi-modal base model based on the second chunk. Since the second chunk reflects the context of the entire target document through the global summary token data as well as the context of the first chunk based on the first summary token data, an embedding vector of the second token data determined through training of the multi-modal base model may be determined to be close to embedding vectors of other highly correlated tokens.

The neural networks, electronic devices, communication interfaces, processors, memories, electronic device 200, communication interface 210, processor 220, and memory 230 described herein, including descriptions with respect to respect to FIGS. 1-8, are implemented by or representative of hardware components. As described above, or in addition to the descriptions above, examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit (ALU), a digital signal processor (DSP), a microcomputer, a programmable logic controller, a field-programmable gate array (FPGA), a programmable logic array (PLU), a microprocessor, or any other device or combination of devices that is configured to respond to and execute instructions (e.g., code or coding) in a defined manner to achieve a desired result. In one example, a processor or computer includes, or is connected to, one or more memories storing the instructions or software that are executed by the processor or computer. Hardware components implemented by a processor or computer may execute the instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both, and thus while some references may be made to a singular processor or computer, such references also are intended to refer to multiple processors or computers. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. As described above, or in addition to the descriptions above, example hardware components may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing. Thus, references to a processor herein mean processing circuitry (e.g., circuitry that includes one or more processing element(s) circuits). One or more processors comprising processing circuitry also refers to each processor comprising processing circuitry, as well as some or all of the one or more processors comprising the same processing circuitry. In addition, processors(s) and controller(s), as a non-limiting example, do not mean human processing or human control, but rather, refer to hardware components as described herein, as non-limiting examples.

The methods illustrated in, and discussed with respect to, FIGS. 1-8 that perform the operations described in this application are performed by computing hardware, for example, by one or more processors or computers, implemented as described above implementing the instructions (e.g., computer or processor/processing device readable instructions) or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations. References to a processor, or one or more processors, as a non-limiting example, configured to perform two or more operations refers to a processor or two or more processors being configured to collectively perform all of the two or more operations, as well as a configuration with the two or more processors respectively performing any corresponding one of the two or more operations (e.g., with a respective one or more processors being configured to perform each of the two or more operations, or any respective combination of one or more processors being configured to perform any respective combination of the two or more operations). Likewise, a reference to a processor-implemented method is a reference to a method that is performed by one or more processors or other processing or computing hardware of a device or system.

The instructions or software to control computing hardware, for example, one or more processors or computers, to implement the hardware components and perform the methods as described above may be written as computer programs, code segments, or other executable instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media, and thus, not a signal per se. Thus, references herein to storage media mean storage media hardware, and does not mean to transitory media, nor a signal per se. As described above, or in addition to the descriptions above, examples of a non-transitory computer-readable storage medium include one or more of any of read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as a multimedia card or a micro card (for example, secure digital (SD) or extreme digital (XD)), magnetic tapes, floppy disks, magneto-optical data storage devices, optical data storage devices, hard disks, solid-state disks, and/or any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. A processor-implemented method, the method comprising:
generating a token data set based on document information of a target document;
generating a first chunk comprising first token data determined based on the token data set;
generating first summary token data for the first chunk;
generating a second chunk based on second token data and the first summary token data, wherein the second token data is determined based on the token data set; and
training a multi-modal base model based on the second chunk.

2. The method of claim 1, wherein a first length of the first token data and a second length of the second token data are less than or equal to a preset first target length.

3. The method of claim 2, wherein a third length of the first chunk and a fourth length of the second chunk are less than or equal to a second target length, the second target length being greater than the first target length.

4. The method of claim 1, wherein the generating of the first summary token data for the first chunk comprises:
generating the first summary token data by processing the first chunk based on a first query for the first chunk.

5. The method of claim 4, wherein the generating of the first summary token data comprises:
generating the first summary token data by inputting the first query and the first chunk to a summary model.

6. The method of claim 1, further comprising:
generating global summary token data based on the token data set,
wherein the generating of the second chunk comprises:
generating the second chunk based on the second token data, the first summary token data, and the global summary token data.

7. The method of claim 1, wherein the target document comprises a portion in which an image and a text intersect with each other.

8. The method of claim 1, wherein the generating of the token data set comprises:
generating first image token data by processing, using an image encoder, a first image of the target document.

9. The method of claim 1, wherein the multi-modal base model comprises a multi-modal large language model (LLM).

10. An electronic device, comprising:
at least one processor comprising processing circuitry; and
a memory comprising one or more storage media configured to store instructions,
wherein the instructions, when executed by the at least one processor, cause the electronic device to:
generate a token data set based on document information of a target document;
generate a first chunk comprising first token data determined based on the token data set;
generate first summary token data for the first chunk;
generate a second chunk based on second token data and the first summary token data, wherein the second token data is determined based on the token data set; and
train a multi-modal base model based on the second chunk.

11. The electronic device of claim 10, wherein a first length of the first token data and a second length of the second token data are less than or equal to a preset first target length.

12. The electronic device of claim 11, wherein a third length of the first chunk and a fourth length of the second chunk are less than or equal to a second target length, the second target length being greater than the preset first target length.

13. The electronic device of claim 11, wherein the instructions, when executed by the at least one processor, cause the electronic device to:
obtain a first query for the first chunk; and
generate the first summary token data by processing the first chunk based on the first query.

14. The electronic device of claim 13, wherein the instructions, when executed by the at least one processor, cause the electronic device to generate the first summary token data by inputting the first query and the first chunk to a summary model.

15. The electronic device of claim 11, wherein the instructions, when executed by the at least one processor, cause the electronic device to:
generate global summary token data based on the token data set; and
generate the second chunk based on the second token data, the first summary token data, and the global summary token data.

16. A processor-implemented method, the method comprising:
generating a token data set based on document information of a target document;
generating global summary token data based on the token data set;
generating a first chunk comprising first token data and the global summary token data, wherein the first token data is determined based on the token data set; and
training a multi-modal base model based on the first chunk.

17. The method of claim 16, further comprising:
generating first summary token data by processing the first chunk based on a first query for the first chunk;
generating a second chunk based on second token data, the global summary token data, and the first summary token data, wherein the second token data is determined based on the token data set; and
training the multi-modal base model based on the second chunk.

18. The method of claim 17, wherein a first length of the first token data and a second length of the second token data are less than or equal to a preset first target length.

19. The method of claim 18, wherein a third length of the first chunk and a fourth length of the second chunk are less than or equal to a second target length, the second target length being greater than the preset first target length.

20. The method of claim 17, wherein the generating of the first summary token data comprises:
generating the first summary token data by inputting the first query and the first chunk to a summary model.
